(19) United States
(12) Patent Application Publication
(10) Pub. No.: US 2015/0227965 A1
(43) Pub. Date: Aug. 13, 2015

(54) METHOD AND SYSTEM FOR EVALUTING SIGNAGE

(71) Applicants: Paul Drysch, Laguna Hills, CA (US); Krishnaraj Inbarajan, Weston, FL (US)

(72) Inventors: Paul Drysch, Laguna Hills, CA (US); Krishnaraj Inbarajan, Weston, FL (US)

(21) Appl. No.: 14/175,009

(22) Filed: Feb. 7, 2014

(51) Int. Cl. G06Q 30/02; G06K 9/62; G06F 17/30; G06K 9/00

(52) U.S. Cl. CPC G06Q 30/0246; G06K 9/00791; G06K 9/6267; G06F 17/30268; G06F 17/3028

(57) ABSTRACT

A method for capturing a scene image of signage from a vehicle moving on a road or from a person's perspective not in a vehicle, the method includes the steps of capturing scene images of signage, recording video data of the scene image of signage into a memory, the video data being formed by image frames, tagging each image frame of the image frames or a group of the image frames with time data and location data, identifying a specific signage in the image frame, counting a least a potential number of people and a potential number of vehicles around the specific signage in the image frame, measuring a viewing angle formed between a driving direction of the vehicle or between a direction of movement of a person not in a vehicle and a viewing direction to the specific signage from the camera, classifying the specific signage into one of signage groups, and forming one or more databases including the classified signage groups and impact of each signage object.

### TECHNICAL FIELD

The present invention relates to a method for rating the effectiveness of signage and a measuring system, the signage being viewed from a vehicle or from a person's perspective not in a vehicle, and particularly relates to a method for rating signage and a road associated with the signage including billboards and traffic signs and a measuring system for evaluating the same from a vehicle or from a person's perspective not in a vehicle.

### BACKGROUND OF THE INVENTION

Billboards are one type of outdoor advertising media for increasing attention and presence of target products. Media companies sell billboard space to their clients for the advertisement of a target product. For example, when a company producing beverages wants to advertise a new product using billboards at several target locations, the company needs to verify the effectiveness of the billboard space. Thus, the media company needs to provide necessary information for clients to select a billboard location suitable for their target product as part of their advertising plan. For example, classification of the people who may potentially view the billboard by ethnicity, estimated age, estimated income level, vehicle types driving around the area where the target billboard is located, and the expected number of people who view the advertisement on the billboard at specific times of the day, specific day of the week, under differing weather and seasonal conditions among other factors need to be considered when planning an advertising campaign.

The present invention has been made considering the above needs, and an objective of the present invention is to provide a method for improving the accuracy of the database information used when selecting the billboard, including its location, as part of an advertising plan for a target product.

### SUMMARY OF THE INVENTION

In accordance with the first aspect of the invention, a method for evaluating signage from a vehicle traveling on a road, the method including the steps of capturing, by at least one camera in the vehicle, imagery of signage, recording, by a processor, video data of the imagery of signage into a memory, the processor being arranged to control the camera, the video data being formed by image frames, tagging each image frame or a group of the image frames of the video data with time data, location data where the imagery of signage is captured, speed data taken from the vehicle network information bus and driving direction data of the vehicle, identifying a specific signage in the image frame, creating, by the processor, a set of evaluation factors to be used for the rating of the specific signage by counting at least a potential number of people or a potential number of vehicles around the specific signage in the image frame, measuring a viewing angle formed between a driving direction of the vehicle and a viewing direction to the specific signage from the camera, classifying the specific signage into one of signage groups, and forming one or more databases including the classified signage groups and impact of each signage object.

According to the first aspect of the present invention, the camera in the vehicle captures a scene image of signage. Then the processor analyzes the video data of the scene image of the signage to count the potential number of people viewing the signage and the potential number of vehicles from which the driver or passengers are expected to view the signage. The processor also measures the viewing angle of the signage from the vehicle. The processor forms one or more databases based on evaluation factors of the signage including the potential numbers of people, vehicles around the signage and viewing angle associated with the signage. Traffic data on road segments, with information including number of vehicles, location, time of day, day of the week, time of year, will allow for more accurate information about number of vehicles/people that view the signage. As a result, the database for signage effectiveness ratings serves as a tool for evaluating the signage based on the potential number of people viewing the signage. In the case that the signage includes billboards used for advertising product, for example, this database can be used as tool for media purchasing organizations to obtain fair prices for advertising space purchases from billboard owning companies.

According to the second aspect of the present invention, the video data of the imagery of the signage captured by the camera and controlled by the processor, and the video data of the imagery of signage processed to tag the necessary information to be used when analyzed may be transferred to a server via a network for applying analysis algorithms, such as data mining algorithms running on the server for forming one or more databases for signage ratings. In both aspects of the present invention, the video data is captured at a quality sufficient for accurate analysis by the analysis algorithms.

According to the third aspect of the present invention, a method for evaluating signage being viewed from a person's perspective not in a vehicle moving through a geography, the method including the steps of capturing, by at least one camera, imagery of signage, recording, by a processor, video data of the imagery of signage into a memory, the processor being arranged to control the camera, the video data being formed by image frames, tagging, by the processor, each image frame of the image frames or a group of the image frames with time data, location data where the imagery of signage is captured, and speed data calculated by using a combination of acceleration data from an accelerometer and location data, identifying, by the processor, a specific signage in the image frame, creating, by the processor, a set of evaluation factors to be used for the rating of the specific signage by counting, by the processor, a least a potential number of people around the specific signage in the image frame, measuring, by the processor, a viewing angle formed between a moving direction and a viewing direction to the specific signage from the camera, classifying, by the processor, the specific signage into a signage group, and forming, by the processor, one or more databases including the classified signage groups.

According to a fourth aspect of the present invention, an algorithm performs a rating of each signage object as well as road sections using evaluation factors including, but not limited to, at least one of the potential viewing time, the potential number of vehicles, the potential number of people viewing the specific signage, demographics of said people viewing the specific signage, viewing angle of the specific signage, type of signage (painted, electronic, video, digital, 3D, etc.), the identified type of vehicle around the specific signage, weather, relative size of the signage, relative brightness of the signage, lane of travel, speed of travel and historical data for all evaluation factors.

### BRIEF DESCRIPTION OF THE DRAWINGS

FIG. 1 illustrates data flow of a signage evaluation system.

FIG. 2 illustrates steps for processing data for a signage evaluation system for signage and a section of road from raw data.

FIG. 3 illustrates a block diagram of a signage evaluation system to be used in vehicles.

FIG. 4 illustrates communications between a signage evaluation system and a server.

FIG. 5 illustrates a block diagram of a signage evaluation system to be operated exterior to a vehicle, moving through a geography in the vicinity of the signage.

FIG. 6 illustrates an embodiment of capturing imagery from a vehicle.

FIG. 7 illustrates a description of viewing angle from a vehicle.

FIG. 8 illustrates a description of viewing angle from a vehicle.

FIG. 9A illustrates an example of an image of a building viewed from a camera positioned in the center of a vehicle between the front seats.

FIG. 9B illustrates an example of an image of the building viewed from a camera moved from the center of a vehicle between the front seats to a position where the driver's head is likely to be.

FIG. 9C illustrates an example of an image of the building viewed from a camera moved from the center of a vehicle between the front seats to a position where the passenger's head is likely to be.

FIG. 10 illustrates an embodiment of the present invention where roadside signage in a captured image frame has different sized characters overlaid on each signage object so that readability of the signage can be evaluate.

### DETAILED DESCRIPTION OF INVENTION

Preferred embodiments of the present invention will hereinafter be explained.

Rating Factors of Signage and Road

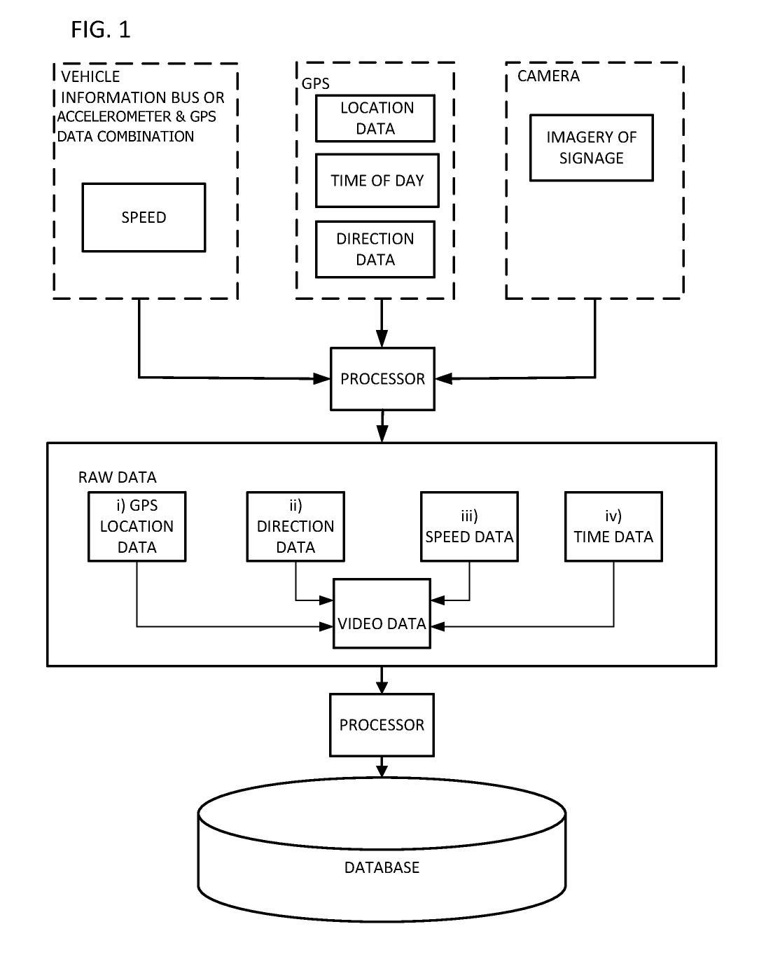

FIG. 1 illustrates data flow of the signage evaluation system. As shown in FIG. 1, information is gathered from a vehicle driving by a signage. The vehicle is equipped with a signage evaluation system which includes at least a vehicle information bus connection, Global Positioning System (GPS) and a camera. The vehicle information bus connection is configured to obtain information of a) speed of the vehicle. Speed data could also be obtained by using a combination of accelerometer data and GPS data. The GPS is configured to obtain b) location data, time of the day when the vehicle is traveling by the signage, and direction data. The camera equipped in the vehicle is configured to capture video data in the form of image frames from which information of c) the number of vehicle visible via the camera, d) the number of people visible via the camera, e) the lane of travel on the road, f) the distance to and/or from the signage, and g) weather conditions in the vicinity of the signage can be calculated.

The information obtained from the vehicle information bus connection, or a possible accelerometer, GPS and the camera attached to the vehicle contribute to two categories: the number of viewers and viewing time of the signage. For instance, the information a) to d) relate to the number of viewers and the information a), b), and e) to g) relate to the viewing time. In this embodiment, the information a) and b) relate to both the number of viewers and the viewing time.

Further, information obtained from the vehicle information bus connection and/or possible accelerometer, GPS and the camera attached to the vehicle is processed by a processor to form raw data. The video data captured by the camera attached to the vehicle is tagged with i) GPS location data, ii) direction data, iii) speed data and iv) time data to form raw data by the processor. Then the raw data is processed by a processor to create a database of the rating factors for evaluating signage. The rating factors for signage as well as road sections in this specification are used to create an accurate rating of signage, such as billboards for commercial advertisement and traffic signs, and a part of road near which the signage are located. Inventors believe that these rating factors are grouped into several factors. These factors include but are not limited to the following: A first factor relates to number of viewers, a second factor relates to time when the signage is viewed, a third factor relates to how long a signage is viewed based on traffic flow and other data, a fourth factor relates to the impact of sun light on the visibility of the signage, a fifth factor relates to the signage brightness which could be rated against a threshold level for the particular type of signage (digital versus painted, video versus static, 2D versus 3D), and a sixth factor relates to the demographics of those viewing the actual signage.

In this embodiment, these raw data described above are defined as the captured image frames of the video for which each frame is tagged with the speed data from the vehicle information bus connection or by using a combination of accelerometer data and GPS data, location data tagged from GPS, direction data tagged from GPS and time data tagged from GPS. The video data is captured by the camera of a signage evaluating system (which will be described later) installed in a vehicle which is driven on the roadway multiple times near which the target signage, for example, billboards, are located and/or operated in the vicinity of the signage exterior to a vehicle.

The number of people potentially viewing the billboard and the number of vehicles near the billboard can be obtained by capturing video images near the target billboard and analyzing the video images to count these numbers which will be described later. Speed information is obtained from the vehicle information bus connection of the vehicle, by using a combination of accelerometer data and GPS data of the system, or additional equipment installed in the vehicle. The lane in which the vehicle is driven, viewing angle from the vehicle on the roadway to the target billboard, and weather conditions can be obtained by analyzing the video data. These are key factors for creating the rating of the target signage.

In this embodiment, as shown in FIG. 1, the raw data described above is processed by algorithms of the signage evaluation system to create a database of signage. The details will be described later.

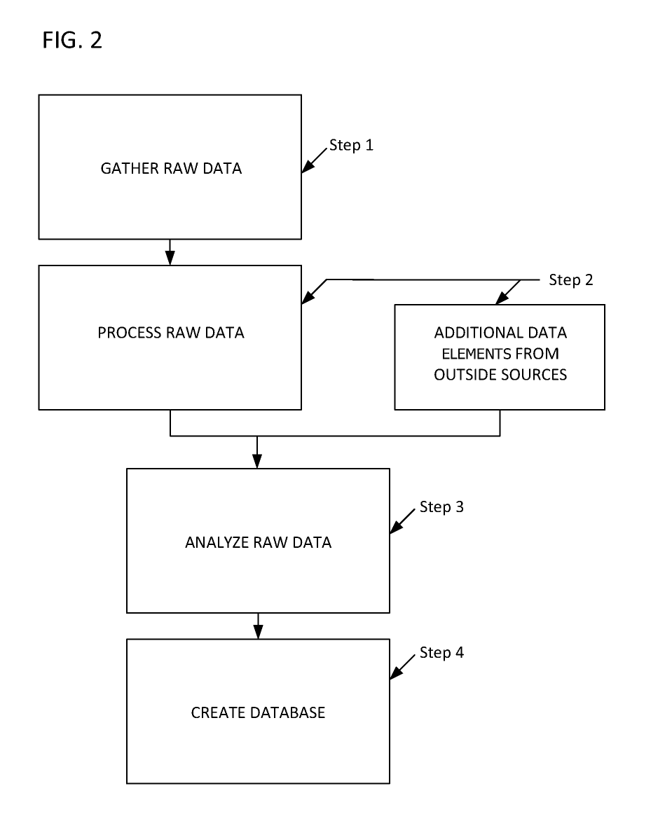

FIG. 2 illustrates a process flow for creating rating factors for signage and road sections from raw data. As described above, the video data is captured by the camera. Speed data is obtained from the vehicle information bus connection or by using a combination of accelerometer data and GPS data, with time, location, and direction data obtained from a GPS (Global Positioning System) installed in the vehicle or in the system itself. (Step1).

Then, the raw data is processed to correlate the captured video data with the time data, the location data, the speed data and the direction data so that the correlated data can be utilized to create the rating factors for the target signage and the road near which the target signage is located. In addition to the data described above, additional data elements, such as traffic data supplied by additional data sources may be combined with the data described above to create the rating factors (Step 2).

Once the captured data is processed and stored in a memory or a computer readable medium being non-transitory, the stored data is then analyzed to create rating factors for the target signage and related road. The target signage is selected from the video frames. Then the number of people and the number of vehicles associated with the extracted target signage in the video frames are counted by algorithms stored in the memory or computer readable medium, which will be executed by the processor. The selected signage is correlated with count data together with time, location and direction data and classified into one of several grades classifying the effectiveness of the signage. Further, additional rating factors, for example, the viewing angles from several different lanes of the roadway, the viewing time from the vehicle of the roadway, weather conditions and other factors are included to increase the accuracy of the database formed by the rating factors. Optionally, at one or more points of the process, additional sources of data, for example traffic data, could be correlated with the existing data, augmenting the data, or combined as a separate set or subset of data to be analyzed by one or more algorithms with the invention not reliant on these additional data sources to be capable of execution.

Signage Evaluation System

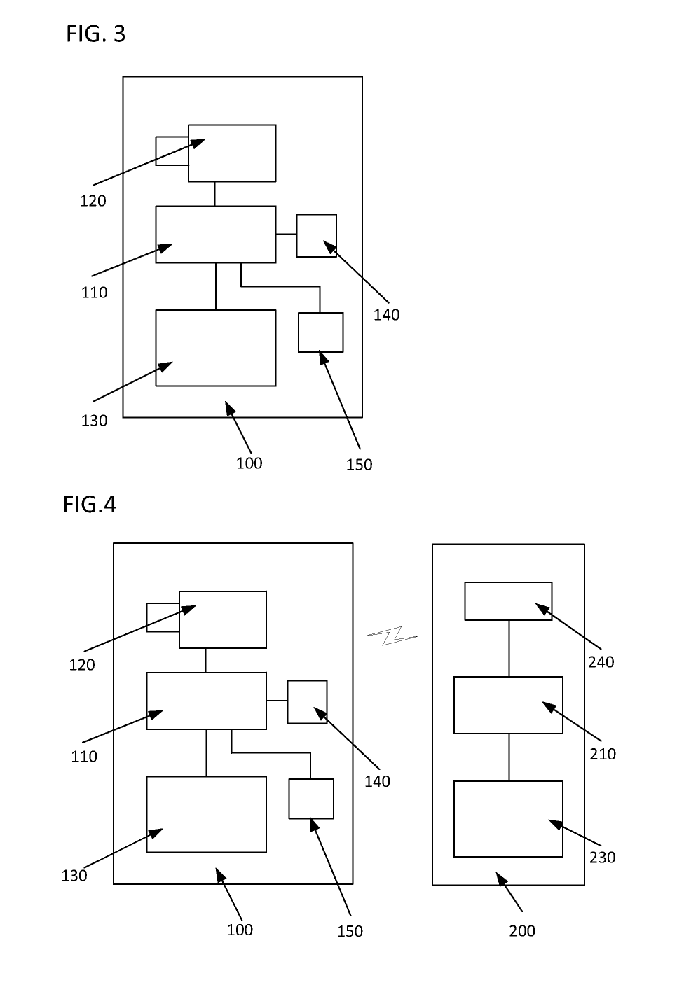

The detail operations of the signage evaluation system will be described hereinafter. FIG. 3 illustrates a block diagram of a signage evaluation system 100 including a camera 120 for capturing imagery, a processor 110 for processing and analyzing image data captured by the camera 120, a memory 130 for storing the image data captured by the camera 120 and algorithms to be running on the processor 11, the memory being non-transitory, a video monitor 150 for viewing video images captured by the camera 120, and a network device 140, which may be a wireless network and/or wired network, for communicating to a server 200 (Refer to FIG. 4) for analyzing the data transmitted via the network. The signage evaluation system 100 is designed to be installed in a vehicle to capture imagery from the perspective of people in the vehicle.

The imagery captured by the camera 120 is transmitted and stored in the memory 130 by algorithms running under control of processor 110. The output of the camera 120 is arranged to be a digital form in this embodiment. However, it may be in analog signal form and digitized by an analog to digital converter before processing the digitized image data. The imagery is captured at a frame rate and resolution sufficient for effective analysis of the video frames.

A distance meter may be installed in the signage evaluation system 100. The distance meter is oriented in the same direction as the camera 120. The distance meter measures the distance from the camera to the target object. For example, when camera 120 captures an image of a billboard located to the side of a road, the distance meter outputs the distance to the billboard from the camera when the camera 120 and the distance meter are installed at the same distance relative to the target signage. The output of the distance meter is transmitted to processor 110 and used to tag the associated images captured by the camera 120. GPS data may also be utilized to specify the current position of the vehicle which may be used to calculate the distance to the target signage by the linking of associated map database information.

Algorithms running on the processor 110 are arranged to transfer the video data captured by the camera 120 to the memory 130. Then algorithms running on the processor 110 identify objects, for example, a target signage, vehicles and people around the target signage. In this step, the time data, location data of where the imagery is captured and distance data is tagged onto each frame of the associated imagery. Further, the direction of vehicle travel at the time of capture of the imagery of signage can be added to the associated frames of the video data.

The process described above is performed by the processor 110 in the signage evaluation system 100 in real time when the processor is capable of executing those tasks in real time. When the capability is not sufficient for real time execution, some or all of the tasks may be executed offline or a part of data may be transmitted to a server system via the network for further processing.

FIG. 4 illustrates the signage evaluation system 100 and a server system 200 which are linked through the network devices 120 and 240. When analyzing the processed data performed by the processor 110 is expected to be heavy for the processor 110 to execute or when offline processing is required, for example, executing 3D processing on the captured video data, the processed data from the processor 110 in the signage evaluation system 100 can be transferred to the server system 200. The server 210 is connected to a memory 230 which could assist the signage evaluation system 100 in, for example, heavy load analysis of captured image data requiring 3D processing or the like. The server system 200, would be capable of performing the same tasks as the signage evaluation system 100, for example, tasks including view point shift operations in a large scale, which will be described later, and allow these tasks to be performed offline or post image capture.

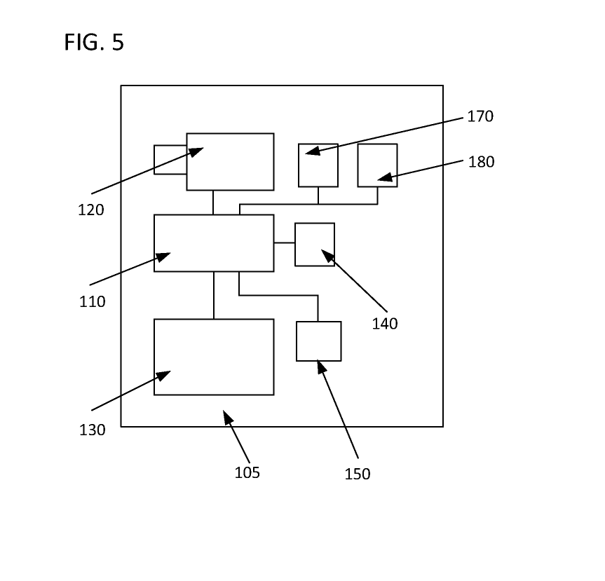

FIG. 5 illustrates a block diagram of a signage evaluation system 105 being designed as a transportable type to be operated without the use of a vehicle in the vicinity of the signage. The signage evaluation system 105 includes a camera 120 for capturing imagery, a processor 110 for processing and analyzing image data captured by the camera 120, a memory 130 for storing the image data captured by the camera 120 and algorithms to be running on the processor 110, the memory 130 being non-transitory, a video monitor 150 for viewing video images captured by the camera 120 which are the same devices as described in FIG. 3, a GPS 170 for providing location data, an accelerometer 180 for supplying acceleration data and a network device 140, which may be a wireless network and/or wired network, for communicating to a server 200 (Refer to FIG. 4) for analyzing the data transmitted via the network. The signage evaluation system 105 is designed to capture imagery from the perspective of a person not in a vehicle while moving near the signage. The signage evaluation system 105 is configured by the same elopements, such as, the processor 110, the camera 120, the memory 130, the network device 140 and the monitor 150 which are used in the signage evaluation system 100 shown in FIG. 3 in addition to the accelerometer 160 and the GPS 170. Further, the basic input and output functions and the algorithms running on the processor 110 are substantially the same as the algorithms used in the signage evaluation system 100 shown in FIG. 3. Further, the signage evaluation system 105 shown in FIG. 5 is designed to be capable of communicating with the server 200 shown in FIG. 4 in this embodiment.

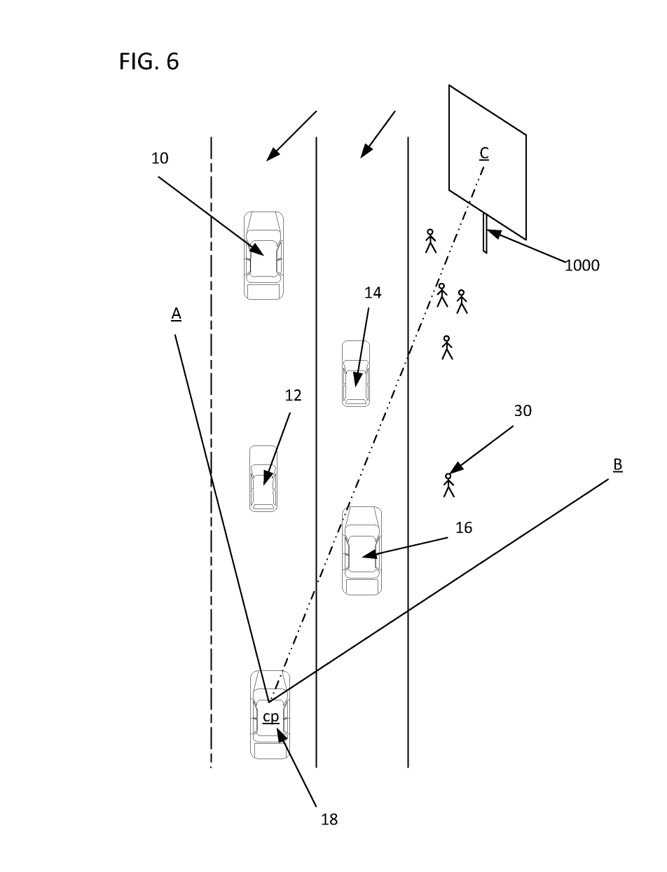

FIG. 6 illustrates the situation where the signage evaluation system 100 installed in a vehicle 18 captures imagery where vehicles 10, 12, 14 and 16 are traveling in front of vehicle 18 on a roadway. And a total of five people are walking near a target billboard 1000.

In this embodiment, the camera 120 is capturing the imagery viewed through the front windshield. In this embodiment, the camera 120 is attached between the driver's seat and the passenger's seat of the vehicle. However, the camera position is not limited to between driver's sheet and passenger's seat. The camera 120 may be attached to the roof of the vehicle or other portions of the vehicle. It is also possible to use a plurality of cameras for capturing imagery outside the vehicle. The distance meter would output the distance to the billboard 1000 from the point of the camera 120. This embodiment could also be extended to allow for capture of signage with a camera while moving through a geography without the use of a vehicle.

In this example shown in FIG. 6, a part of the image of the vehicle 10 overlaps the imagery of vehicle 12. In order to correctly count the number of vehicles in each frame of the imagery captured by the camera 120, image data of each vehicle on each frame is correlated to each other until the overlapped vehicle (vehicle 12) moves away from the images of the overlapping vehicle 10. In this embodiment, the number of vehicles being four and the number of people being five are identified for a certain period of time.

In order to calculate the number of people around the target signage, for example, the target billboard, an infrared camera can be used in addition to a normal camera. Further, when counting the number moving targets, such as moving vehicles or people, several algorithms can be utilized for improving the accuracy of the count of moving objects.

Evaluation Factors

In this embodiment, the target signage is a billboard 1000. To evaluate the impact of the space of billboard 1000, evaluation factors or rating factors need to be obtained. As for the evaluation factors, inventors have selected the number of people who may view the billboard 1000, the number of vehicles around the billboard, the number of people in the vehicles driving in the vicinity of the billboard 1000, the viewing time of the billboard from a vehicle traveling in a lane on a road in the vicinity of the billboard, the distance to the billboard 1000, the size of the billboard 1000 viewed from the vehicle, type of signage (painted, electronic, video, digital, 3D, etc.), and viewing angle of the billboard 1000 from the vehicle.

The number of potentially moving targets, in this case people walking around the billboard and vehicles, can be counted by applying algorithms to each frame of captured video. With respect to the number of people in the vehicles, due to the overlap of the images, sometimes it may be necessary to manually confirm the number of people inside the vehicles using the captured video frames. Also, by identifying features specific to certain vehicles through the algorithm, vehicle type, for example passenger cars or pickup trucks, and even the maker of the vehicle, could be identified, which would be used to improve the rating factors of billboard effectiveness.

The distance to the billboard 1000 from the point of the camera 120 could be measured using a distance meter installed together with the camera 120 in the signage evaluation system 100. The distance data changes as the vehicle travels on the roadway and will be associated with the each signage object in each of the video frames. If the distance can be measured by a distance meter, the estimated or calculated size of the billboard as it is observed can be obtained by comparing the observed image of the billboard 1000 with the reference size on the video frames. Alternatively, distance data could be calculated using the GPS position data tagged on each frame by the evaluation system as it is recorded and the GPS position data of the signage on a map. Additionally, if an approved and authorized database of either GPS location data or actual signage sizes is available, then that data could be used, either in the calculation of the signage size or using the raw signage size data depending on the type of database.

The viewing angle can be obtained by comparing the viewing direction from the camera 120 with the traveling direction of the vehicle 18. The traveling direction can be obtained from a GPS system installed in the vehicle which is tagged on each video frame of the target signage together with the time data and location data also supplied from the installed GPS in the vehicle 18.

The viewing time can be obtained by extracting the target object from the video frames captured by the camera 120. When the target object is identified in the video frame and passes a certain threshold where it is deemed to be effective, the processor obtains the time information from the tagged time data associated with the video frame (start of viewing time). Then, at a certain threshold where the object is deemed to be ineffective, the controller obtains the time information from the tagged time data associated with the video frame (end of viewing time). The viewing time can be calculated from the start of viewing time and the end of the viewing time.

It is also important to have data for direction of travel on the road as a rating factor of the target signage, for example, the billboard 1000 because the billboards for outdoor advertisements are situated in places thought most likely to be viewed from the road near the billboard. In the case of a metropolitan area, traffic conditions change depending on time of day and based on the direction of travel on the road. For, example, traffic is very heavy on a road heading to an office area from a residential area in the morning. In the evening the heavy traffic occurs in the opposite direction. In this case, viewing time of a billboard near a road will change based on the time of a day. This means that the direction of the vehicles driving on the road needs to be included in the rating factors of the target billboard.

Also, the number of people and the number of vehicles around the billboard will be observed at least enough times in a day to create a statistically viable sample space to obtain accurate rating factors of the billboard based on each time slot of the day.

The weather also affects the rating factors for the captured imagery of the billboard and imagery around the billboard. For example, in places where morning fog and evening fog tend to appear through the year, the value of an outdoor billboard in such a place is relatively lower than a place where morning and evening fog seldom appear through the year. Other weather conditions, for example rain and snow, would also affect the visibility and thus rating factors of a target signage. Weather conditions can be calculated from the image frames captured by the video camera 120.

It is also possible to obtain weather information from related entities and add it to the information in the signage evaluation database when it is created.

Further, in an embodiment of the present invention, voice and text information could be added as side information associated with the target billboard. When capturing the imagery of the target object, special comments can be added using this function. Using this function, it becomes possible to add side information which can be associated with the target object, for example, a new building is under construction near the target object. This may be side information which could not be captured by the video when construction is in the initial stage. However, this function can increase the value of the rating factors of the target signage object when it is combined with associated rating factors.

Viewing Angle & Viewing Position

Returning to FIG. 6, in an embodiment of the present invention illustrated in FIG. 6, the roadway on which the vehicle 18 with the installed signage evaluation system 100 travels has two lanes of travel in one direction of the roadway and the vehicle 18 travels in the first lane. The viewing angle in the lateral direction to the billboard 1000 is defined as following in this specification. The viewing angle from the point of the camera of the signage evaluation system 100 in the lateral direction is defined as an angle formed between the driving direction of the vehicle having the signage evaluation system and the viewing direction from the camera to the center of the billboard 1000 if it were to be viewed straight on.

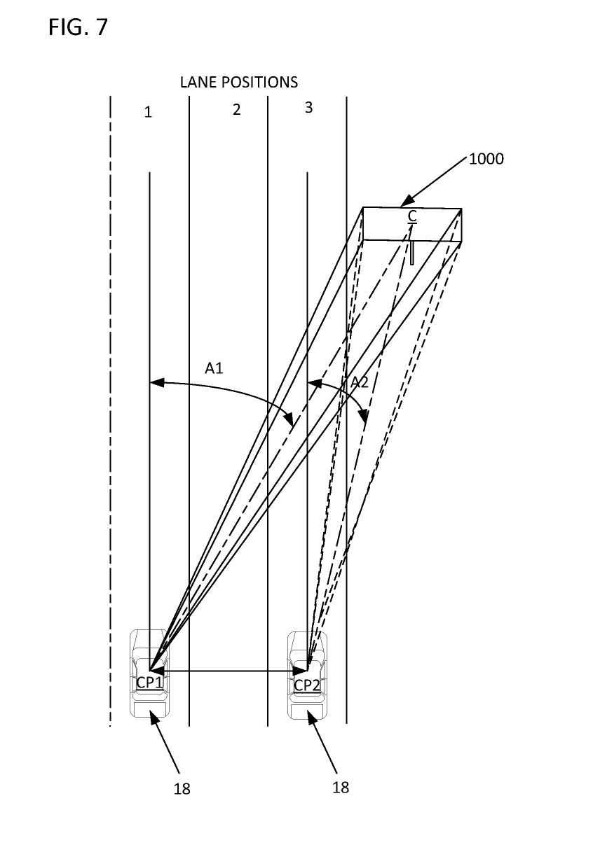

FIG. 7 illustrates viewing angles of the billboard 1000 viewed from the camera points CP1 and CP2 in the vehicle 18 traveling on lanes 1 and 3. The viewing angle in the lateral direction viewed from the vehicle 18 traveling on lane 1 is “A1” and the viewing angle in the lateral direction viewed from the vehicle 18 traveling on lane 3 is “A2”. In this case angle “A1” is larger than the angle “A2”. If the billboard 1000 faces the driving direction at a substantially perpendicular angle, a viewer having a smaller viewing angle tends to perceive a larger billboard. A viewer having a larger viewing angle tends to perceive a smaller billboard, more skewed, compared with the viewer having a smaller viewing angle. To account for this difference, the viewing angle is included as one of the rating factors of the signage.

In this embodiment, the viewing angle can be obtained by measuring the angle between the driving direction and the viewing direction from the point of the camera to the target object by using captured images from the video frames.

In this embodiment, in order to obtain rating factors for each lane of the roadway, the vehicle 18 with the signage evaluating system 100 installed travels on each lane of the roadway to capture the same specific target object so that the rating factors can be obtained from the captured imagery as described above. The information regarding the lane of travel, including HOV lane or regular lane, is calculated along with traffic speed history on each segment being travelled, which will allow for a more exact number of people viewing a target signage and also allow for the duration of viewing at different times of day based on historic traffic patterns, all referenced against posted speed for that section of the road. By gathering data from multiple lanes, accommodation for obstructions of view for a specific signage, static or moving, can be included, increasing the quality of the database.

Based on the position of the camera attached to the vehicle, and the location of driver and passenger of a vehicle, computation is performed to shift a captured image so that the shifted image is similar to that viewed by driver or passenger. This shift can be done in real-time, post image capture, or after transmitting the captured data to a server. The shifting of a captured image will be explained later.

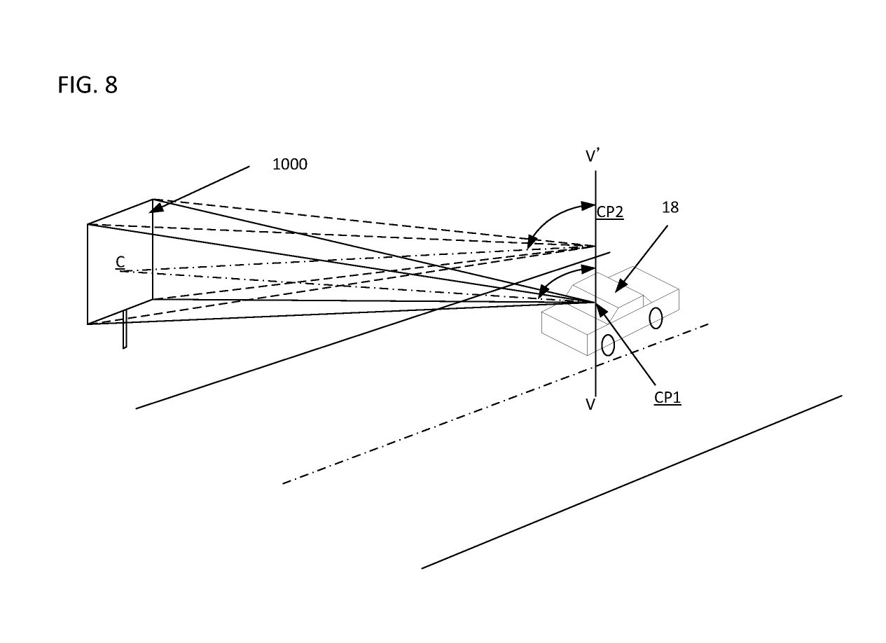

The view point shift function can be applied not only to the view point shift in the lateral direction, but also to the view point shift in the vertical direction. FIG. 8 shows the view point shift function applied in the vertical direction. The viewing angles from different heights may be used when viewing the target signage in several different driving positions, for example, the driving positions of normal passenger vehicles, RVs, trucks and tractors. Thus, the line of sight of a driver is taken into consideration, to accommodate for passenger cars/trucks and tractors being driven along a road segment. This impacts the type of signage viewed and also the duration and angle of view. By providing rating factors based on the viewing angles at different heights, it becomes possible to provide data on a wide range of scenarios for the rating of signage.

Viewpoint Shift

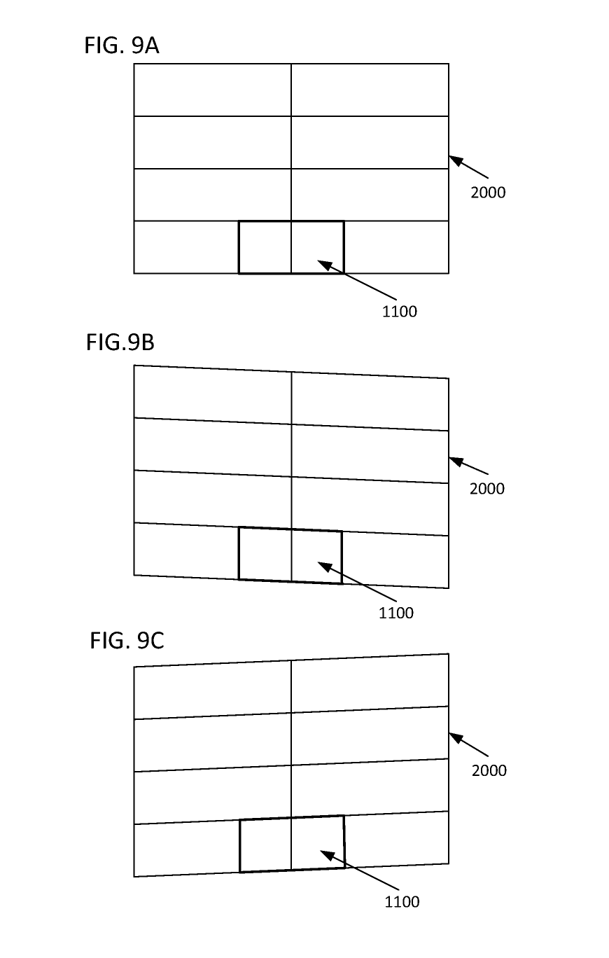

FIG. 9A illustrates an example image of a building 1100 in the captured image frame 2000 viewed from a camera 120 of the evaluation system 100 positioned in the center of the vehicle between the front seats (Position A). FIG. 9B illustrates an example image of the same building 1100 viewed from the camera moved from the center between the front seats to a position where the driver's head is likely to be (Position B). As illustrated, the captured image is slightly oblique comparing with the image shown FIG. 9A. This is because the camera position moves against the position of the building 1100. FIG. 9C illustrates an example image of the same building 1100 viewed from the camera moved from the center between the front seats to a position where the passenger's head is likely to be (Position C). As illustrated, the image is slightly oblique in the other direction comparing with image illustrated in FIG. 9B.

Before capturing video by the camera 120 from the position A (Refer to FIG. 9A) while traveling on a road, the image from each position is captured by physically moving the camera 120 at positions, A (Refer to FIG. 9A), B (Refer to FIG. 9B) and C (Refer to FIG. 9C) to capture the image from respective position. Then processor 110 calculates the differences between images captured at positions A and B, and A and C so that the shift amount related to the images can be applied to each frame of the captured video data to obtain image data shifted from positions A to B and positions A to C.

This calibration needs to be performed before analyzing the image data to obtain the images from shifted view points. The same kind to calibration can be performed at not only several points in the lateral direction but also several positions in the vertical direction.

Rating of Readabilty

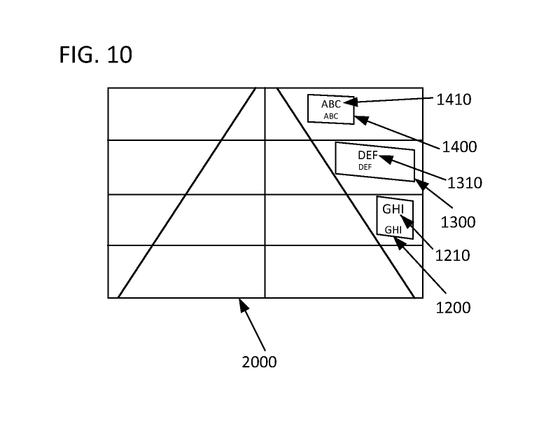

FIG. 10 illustrates an embodiment of the present invention where roadside signage to which different sizes of characters are overlaid to each piece of signage so that readability of the characters can be tested using actual video images. To increase the accuracy of the ratings, and make them independent of the contents of the signs, first, each signage object in the video frames is identified. Then, in the second step, a mask is overlaid on each signage object in the video frames. The mask has a standard set of different sized letters on it (much like a vision chart). Then, in the third step, after the mask is overlaid on each signage object, the processor 110 or the server 210 calculates objectively the rating of the sign using the characters without having the rating related to the contents. This would allow, for example, there to be a “readability” rating. Each sign can be given a recommended minimum font size to make it optimally readable for the most time. This also helps increase accuracy of time of viewing.

Other possibilities with the application of a virtual mask would be to give a “best color” rating. According to this masking operation function, this operation can recommend which color would be the best, based on the location and direction the sign is facing. For example, if the sign is facing east, then it may want to have bolder colors be more visible during sunset when most drivers are viewing the sign on their drive home. Another possibility would be to give a “best type” rating. By using the mask function, this operation could recommend what type (painted, digital, static, 3-D, etc.) of signage would be most effective at a particular location. This could involve a number of factors, including but not limited to environmental-related rating factors from the database information associated with a particular signage.

Classification of Signage

The processor 110 classifies the target signage into a signage group based on the obtained rating factors. When analyzing the captured video frames using the server 210 (FIG. 4), for example, the server 210 classifies the target signage into a signage group based on the obtained rating factors. Then the processor 110 and/or the server 210 forms one or more databases including classified signage groups, which can improve the accuracy of the database information used when selecting a billboard and making an advertising plan for the target product to be advertised.

Thus, the rating factors for evaluating the signage, for example, billboard, used for outdoor advertisements has been described. However, the method for obtaining the rating factors for signage are not limited to billboards. An embodiment of the present invention can be applied to obtaining rating factors of traffic signals, other signs put on the walls of buildings and other structures. Also, an embodiment of the present invention described above can be applied to obtain the rating factors of a section of the road which may be suitable for installing a new billboard for outdoor advertisements.

The operations and features of an embodiment of the present invention are mainly described using a signage evaluation system 100 being installed in a vehicle. However, the same kind of operations and features can be realized by using evaluation system 105 being designed to be operated exterior to, and independently of, a vehicle.

What is claimed is:

1. A method for evaluating signage from a vehicle traveling on a road, the method comprising the steps of:
capturing, by at least one camera in the vehicle, imagery of signage;
recording, by a processor, video data of the imagery of signage into a memory, the processor being arranged to control the camera, the video data being formed by image frames;
tagging, by the processor, each image frame of the image frames or a group of the image frames with time data, location data where the imagery of signage is captured, speed data taken from a vehicle information bus connection, and driving direction data of the vehicle;
identifying, by the processor, a specific signage in the image frame;
counting, by the processor, a least a potential number of people or a potential number of vehicles around the specific signage in the image frame;
measuring, by the processor, a viewing angle formed between a driving direction of the vehicle and a viewing direction to the specific signage from the camera;
classifying, by the processor, the specific signage into a signage group; and
forming, by the processor, one or more databases including the classified signage groups.

2. The method for evaluating signage from a vehicle according to the claim 1, the method further comprising:
shifting, by the processor, in a lateral direction and/or a vertical direction the image frame to a different view point from within the vehicle.

3. The method for evaluating signage from a vehicle according to the claim 1, the method further comprising:
calculating, by the processor, a potential viewing time of the specific signage using at least the time data associated with the image frames of the specific signage.

4. The method for evaluating signage from a vehicle according to the claim 1, the method further comprising:
identifying, by the processor, types of vehicles around the specific signage in the image frame and types of people.

5. The method for evaluating signage from a vehicle according to the claim 1, the method further comprising:
rating, by the processor, the signage using evaluation factors including at least one of a potential viewing time, the potential number of vehicles, the potential number of people viewing the specific signage, viewing angle of the specific signage and an identified type of vehicle around the specific signage.

6. The method for evaluating signage from a vehicle according to the claim 1, the method further comprising:
rating, by the processor, a section of the road using evaluation factors including at least one of a potential viewing time, the potential number of vehicles, the potential number of people viewing the specific signage, viewing angle of the specific signage and an identified type of vehicle around the specific signage.

7. The method for evaluating signage from a vehicle according to the claim 1, further comprising:
capturing, by the camera, an image of a lane on the road on which the vehicle is traveling, the lane being a HOV (High-Occupancy-Vehicle) lane or a regular lane, wherein information associated with the lane is captured along with traffic speed history on each segment being travelled.

8. The method for evaluating signage from a vehicle according to the claim 1, further comprising:
analyzing, by the processor, weather of each frame of the video data.

9. The method for evaluating signage from a vehicle according to the claim 1, wherein the signage includes at least one of a traffic sign and a billboard.

10. The method for evaluating signage from a vehicle according to the claim 1, wherein the identified specific signage in the image frame is overlaid by a mask including a character set having several sizes of characters.

11. A method for evaluating signage from a vehicle traveling on a road, the method comprising the steps of:
capturing, by at least one camera in the vehicle, imagery of signage;
recording, by a processor, video data of the imagery of signage into a memory, the processor being arranged to control the camera, the video data being formed by image frames;
transmitting, by the processor, the video data to a server via network for analysis of signage;
tagging, by the processor, each image frame of the image frames or a group of the image frames with time data, location data where the imagery of signage is captured, speed data and driving direction data of the vehicle;
identifying, by the server, a specific signage in the image frame;
counting, by the server, a least a potential number of people or a potential number of vehicles around the specific signage in the image frame;
measuring, by the server, a viewing angle formed between a driving direction of the vehicle and a viewing direction to the specific signage from the camera;
classifying, by the server, the specific signage into one of signage groups: and
forming, by the server, one or more databases including the classified signage groups.

12. The method for evaluating signage from a vehicle according to the claim 11, the method further comprising:
shifting, by the processor, in a lateral direction and/or a vertical direction the image frame to a different view point from within the vehicle.

13. The method for evaluating signage from a vehicle according to the claim 11, the method further comprising:
calculating, by the server, a potential viewing time of the specific signage using at least the time data associated with the image frames of a specific signage.

14. The method for evaluating signage from a vehicle according to the claim 11, the method further comprising:
identifying, by the server, types of vehicles around the specific signage in the image frame and types of people.

15. The method for evaluating signage from a vehicle according to the claim 11, the method further comprising:
rating, by the server, the signage using evaluation factors including at least one of a potential viewing time, the potential number of vehicles, the potential number of people viewing the specific signage, viewing angle of the specific signage and an identified type of vehicle around the specific signage.

16. The method for evaluating signage from a vehicle according to the claim 11, further comprising:
capturing, by the camera, imagery of a lane on the road in which the vehicle is traveling, the lane being a HOV (High-Occupancy-Vehicle) lane or a regular lane, wherein information associated with the lane is captured along with traffic speed history on each segment being travelled.

17. The method for evaluating signage from a vehicle according to the claim 11, further comprising:
analyzing, by the processor, weather of each frame of the video data.

18. The method for evaluating signage from a vehicle according to the claim 11, wherein the signage includes a traffic sign and a billboard.

19. The method for evaluating signage from a vehicle according to the claim 11, wherein the identified specific signage in the image frame is overlaid by a mask including a character set having several sizes of characters.

20. A method for evaluating signage from the perspective of a person not in a vehicle moving around the signage, the method comprising the steps of:
capturing, by at least one camera, imagery of signage;
recording, by a processor, video data of the imagery of signage into a memory, the processor being arranged to control the camera, the video data being formed by image frames;
tagging, by the processor, each image frame of the image frames or a group of the image frames with time data, location data where the imagery of signage is captured, and moving speed data calculated by using a combination of an cancellation obtained from a accelerometer and the location data;
identifying, by the processor, a specific signage in the image frame;
counting, by the processor, a least a potential number of people around the specific signage in the image frame;
measuring, by the processor, a viewing angle formed between a moving direction of the people and a viewing direction to the specific signage from the camera;
classifying, by the processor, the specific signage into a signage group; and
forming, by the processor, one or more databases including the classified signage groups.
